(19) United States
(12) Patent Application Publication
(10) Pub. No.: US 2026/0196654 A1
(43) Pub. Date: Jul. 9, 2026

(54) TRACTION BATTERY PACK VENTING SYSTEM WITH DETACHABLE SHIELD FOR COATED AREA

(71) Applicant: Ford Global Technologies, LLC, Dearborn, MI (US)

(72) Inventors: Liangjun Hu, Bloomfield Hills, MI (US); Jianwen Yi, West Bloomfield, MI (US); Xinlei Zhou, Canton, MI (US); Brad Alan VanDerWege, Plymouth, MI (US); Steven T. Wooldridge, Manchester, MI (US)

(21) Appl. No.: 19/008,884

(22) Filed: Jan. 3, 2025

(51) Int. Cl. H01M 50/367; H01M 10/613; H01M 10/625; H01M 10/6567; H01M 10/658; H01M 50/213; H01M 50/224; H01M 50/231; H01M 50/249

(52) U.S. Cl. CPC H01M 50/367; H01M 10/613; H01M 10/625; H01M 10/6567; H01M 10/658; H01M 50/213; H01M 50/224; H01M 50/231; H01M 50/249; H01M 2220/20

(57) ABSTRACT

A traction battery pack venting system includes one or more battery cells, and a venting chamber adjacent the one or more battery cells. The one or more battery cells are configured to vent into the venting chamber. A detachable shield transitions from an attached position to a detached position by vent byproducts emitted from one or more battery cells. A guide system constrains movement of the detachable shield when the detachable shield is in the detached position.

### TECHNICAL FIELD

This disclosure relates generally to a venting system for a battery pack and, more particularly, to a venting system for a battery pack that shields coated areas, such as electrocoated areas, of the battery pack from vent byproducts.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. The traction battery pack is discharged when powering the one or more electric machines and other loads of the electrified vehicle.

### SUMMARY

In some aspects, the techniques described herein relate to a traction battery pack venting system, including: one or more battery cells; a venting chamber adjacent the one or more battery cells, the one or more battery cells configured to vent into the venting chamber; a detachable shield that is transitioned from an attached position to a detached position by vent byproducts emitted from one or more battery cells; and a guide system that constrains movement of the detachable shield when the detachable shield is in the detached position.

In some aspects, the techniques described herein relate to a traction battery pack venting system, further including a wall of the battery pack, the one or more battery cell each configured to vent a flow of vent byproducts toward the wall, the guide system configured to maintain the detachable shield in a position between the flow of vent byproducts and the wall.

In some aspects, the techniques described herein relate to a traction battery pack venting system, wherein the wall is at least partially electrocoated.

In some aspects, the techniques described herein relate to a traction battery pack venting system, wherein the wall is an outer wall of an enclosure.

In some aspects, the techniques described herein relate to a traction battery pack venting system, wherein at least the outer wall is a coated metal or a coated metal alloy.

In some aspects, the techniques described herein relate to a traction battery pack venting system, wherein the one or more battery cells are immersion cooled.

In some aspects, the techniques described herein relate to a traction battery pack venting system, wherein the one or more battery cells are cylindrical battery cells.

In some aspects, the techniques described herein relate to a traction battery pack venting system, wherein the venting chamber is sealed from a cell chamber that encloses the one or more battery cells such that liquid communicated through the cell chamber as part of an immersion thermal management system is blocked from entering the venting chamber.

In some aspects, the techniques described herein relate to a traction battery pack venting system, further including a cell carrier having a platform that supports the one or more battery cells.

In some aspects, the techniques described herein relate to a traction battery pack venting system, wherein the detachable shield includes a piece of thermal shield that is disposed adjacent the platform.

In some aspects, the techniques described herein relate to a traction battery pack venting system, wherein the platform includes a plurality of vent openings, the one or more battery cells each configured to vent into the venting chamber through at least one of the vent openings within the plurality of vent openings.

In some aspects, the techniques described herein relate to a traction battery pack venting system, wherein the guide system includes a plurality of fingers each extending from the platform into the venting chamber, the plurality of fingers each disposed about at least one of the vent openings within the plurality of vent openings.

In some aspects, the techniques described herein relate to a traction battery pack venting system, wherein the detachable shield includes a portion of a case of the respective battery cell.

In some aspects, the techniques described herein relate to a traction battery pack venting system, further including a cell carrier having a platform that supports the one or more battery cells, the platform includes a plurality of vent openings, the one or more battery cells each configured to vent through one or more of the vent openings into the venting chamber, the detachable shield configured to pass through the one of the vent openings when in the detached position.

In some aspects, the techniques described herein relate to a traction battery pack venting system, wherein the detachable shield further includes a piece of a thermal shield.

In some aspects, the techniques described herein relate to a traction battery pack venting system, wherein the thermal shield is a mica sheet.

In some aspects, the techniques described herein relate to a battery pack shielding method, including: venting a battery cell into a venting chamber; during the venting, transitioning a detachable shield from an attached position to a detached position; and constraining movement of the detachable shield during the venting.

In some aspects, the techniques described herein relate to a battery pack shielding method, further including managing thermal energy using a liquid coolant, the battery cell at least partially immersed in the liquid coolant.

In some aspects, the techniques described herein relate to a battery pack shielding method, wherein movement of the detachable shield is constrained to maintain the detachable shield in a position where the detachable shield blocks a flow of vent byproducts from impinging on a portion of a wall of an enclosure that houses the battery cell.

In some aspects, the techniques described herein relate to a battery pack shielding method, wherein the wall is at least partially electrocoated.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective view of a battery cell from the battery pack of FIG. 1.

FIG. 3 illustrates another perspective view of the battery cell of FIG. 2 when the battery cell is venting.

FIG. 4 illustrates a perspective view of the battery pack from the electrified vehicle of FIG. 1 according to an exemplary embodiment of the present disclosure.

FIG. 5 illustrates an expanded view of the battery pack of FIG. 4.

FIG. 6 illustrates a section view taken at line 6-6 in FIG. 4.

FIG. 7 illustrates a bottom view of a portion of the cell carrier.

### DETAILED DESCRIPTION

This disclosure details exemplary traction battery packs with venting systems. The venting systems can include a venting chamber. During a thermal event, battery cells can vent into the venting chamber. A detachable shield can prevent vent byproducts discharged from one or more battery cells from impinging directly on the outer wall, which can be coated.

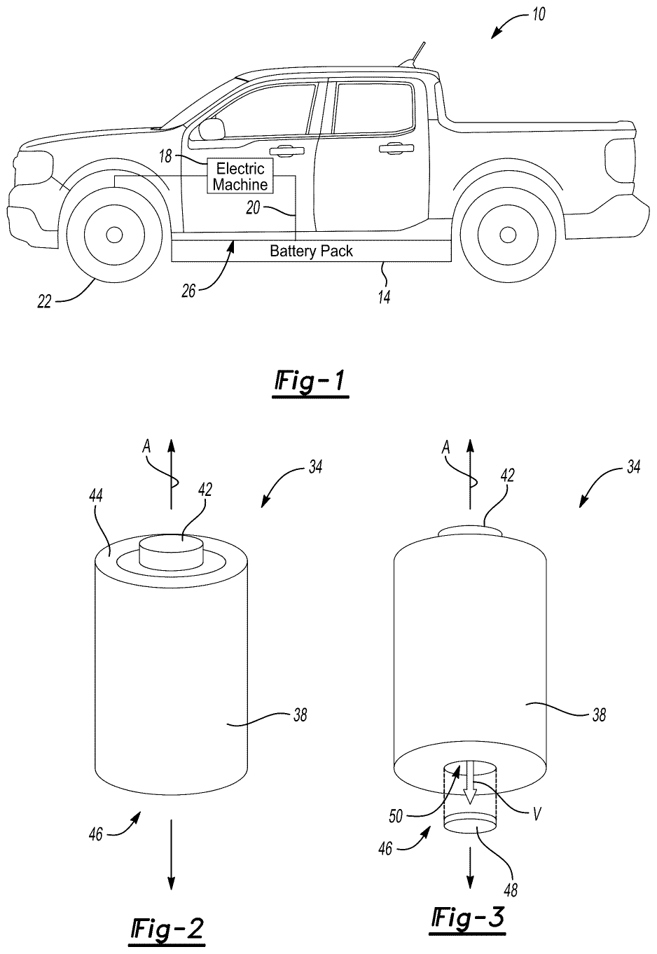

With reference to FIG. 1, an electrified vehicle 10 includes a battery pack 14, an electric machine 18, and wheels 22. The battery pack 14 powers the electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

With reference now to FIGS. 2 and 3, the battery pack 14 of the exemplary embodiment includes a plurality of battery cells 34. The battery cells 34 are cylindrical, lithium-ion battery cells in this example. In particular, the example battery cells 34 each have a jellyroll-style electrode structure housed within an case 38. The cylindrical battery cells 34 are each disposed along a respective battery cell axis A.

A cap 42 of the case 38 provides a positive terminal at a first axial end of each cell 34. The cap 42 is raised above a ring 44, which provides a negative terminal at the first axial end of each cell 34. Busbars can connect to the terminals provided by the caps 42 and rings 44 of the cells 34 to electrically couple the cells 34 to other cells 34, to other components of the battery pack 14, or both. The busbars are omitted from the figures.

A venting side 46 of the case 38 is located at an opposite, second axial end of each cell 34. The case 38 includes a detachable shield 48 on the venting side 46. The case 38 can be thinned about a periphery of the detachable shield 48 to establish an outer periphery of the detachable shield 48.

During a thermal event in one of the cells 34, pressure increases can separate the detachable shield 48 from the remaining portions of the case 38. In particular, the increased pressure can rupture the case 38 at the thinned areas, which can cause the detachable shield 48 to transition from an attached position to a detached position. Transitioning the detachable shield 48 to the detached position provide an opening 50 in the case 38. Vent byproducts V can then pass through the opening 50.

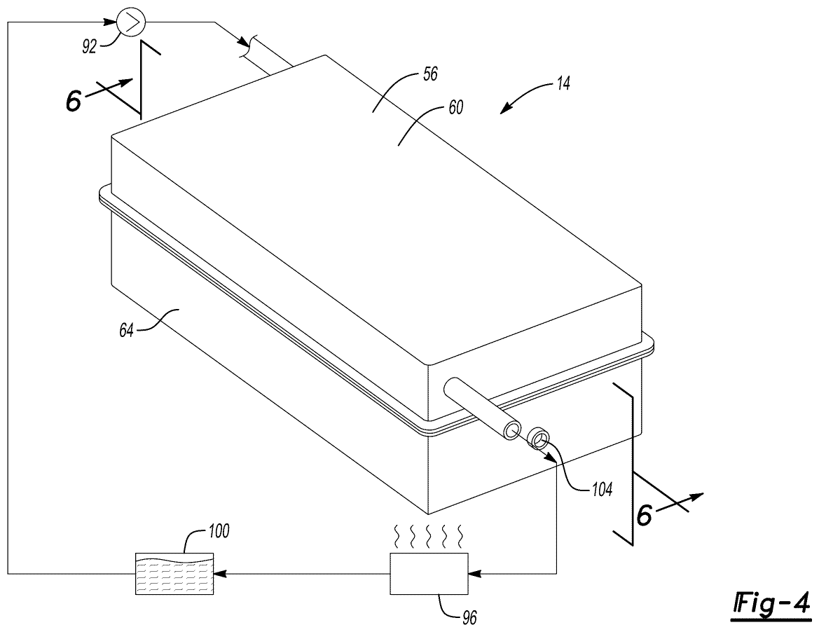

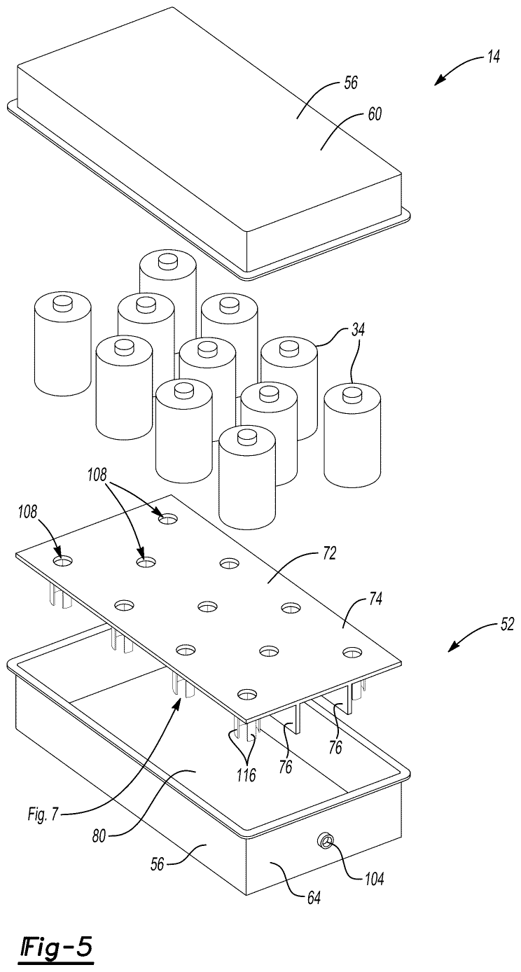

With reference now to FIGS. 4-7 and continuing reference to FIGS. 1-3, the example battery pack 14 houses the batteries 34 an interior 52 of an enclosure assembly 56. In the exemplary embodiment, the enclosure assembly 56 includes an enclosure cover 60 and an enclosure tray 64. The enclosure cover 60 can be secured to the enclosure tray 64 to provide the interior 52 that houses the battery cells 34. The enclosure cover 60 can be secured to the enclosure tray 64 using mechanical fasteners (not shown), for example.

Within the interior 52, the battery cells 34 are supported on a platform 72 of a cell carrier 74. Legs 76 of the cell carrier 74 extend downward from the platform 72 to a floor 80 of the enclosure tray 64 to elevate the platform 72 above the floor 80 within the interior 52. The platform 72 divides the interior 52 into a cell chamber 84 and a venting chamber 88. The cell carrier 74 can be a polymer-based material reinforced with glass fibers.

The example battery pack 14 manages thermal energy of the battery cells 34 and other components of the battery pack 14 using a liquid coolant. The cells 34 and other components of the battery pack 14 are at least partially immersed in the liquid coolant. Thermal energy within the battery pack 14 is thus managed using an immersion thermal management system. In other examples, instead of being immersed in the liquid coolant, the battery cells 34 could be disposed adjacent a thermal exchange plate, and liquid coolant could be routed through the thermal exchange plate to manage thermal energy of the battery cells 34.

In this example, the liquid coolant cools the battery cells 34 and the other components of the battery pack 14. In another example, the liquid coolant could instead or additionally be used to heat the battery cells 34 and the other components. The liquid coolant can be a dielectric coolant, for example.

In this example, a pump 92 circulates the liquid coolant through the cell chamber 84. The platform 72 blocks the liquid coolant from entering the venting chamber 88. The battery cells 34 are enclosed within the cell chamber 84.

Within the cell chamber 84, the liquid coolant moves over the battery cells 34 and other components and takes on thermal energy from the battery cells 34 and the other components. The liquid coolant then moves from the battery pack 14 to a thermal exchange device 96. Thermal energy can be transferred away from the liquid coolant at the thermal exchange device 96.

From the thermal exchange device 96, the liquid coolant moves to a liquid supply 100. The liquid coolant is drawn from the liquid supply 100, as required, and circulated by the pump 92 back to the battery pack 14.

The platform 72 separates the venting chamber 88 from the cell chamber 84 such that liquid coolant communicated through the cell chamber 84 as part of the immersion thermal management system is blocked from entering the venting chamber 88. The venting chamber 88 is sealed from the cell chamber 84.

The battery pack 14 includes a vent 104 within the enclosure tray 64. Vent byproducts V discharged into the venting chamber 88 from one or more of the battery cells 34 can exit the enclosure assembly 56 through the vent 104. Vent byproducts V received within the venting chambers 88 can flow to the gap G through the vent 104.

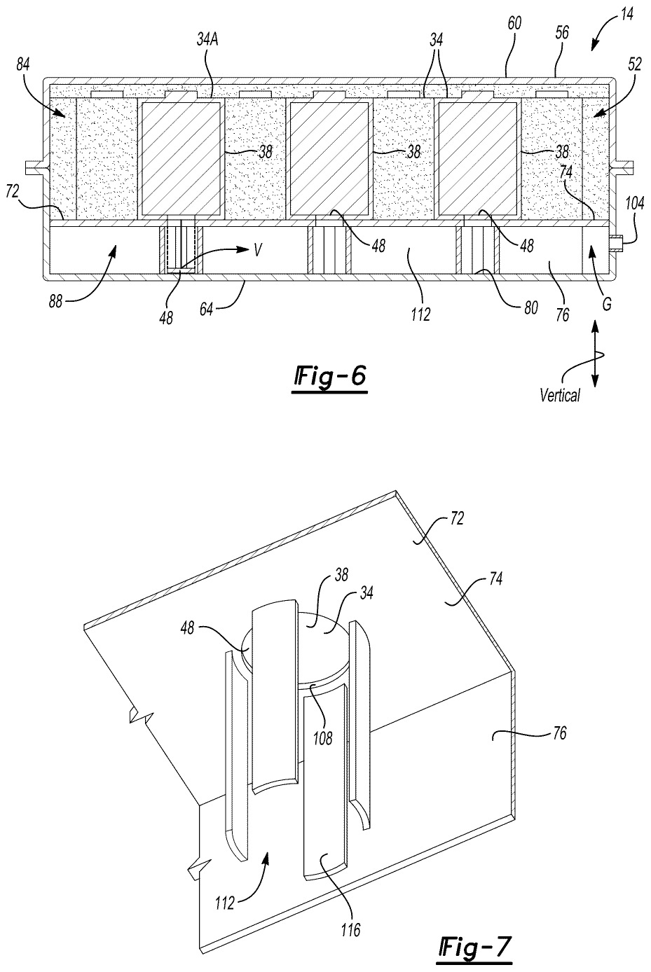

The venting chamber 88 is adjacent the battery cells 34. To provide a passageway to the venting chamber 88, the platform 72 includes a plurality of vent openings 108. Each vent opening 108 is aligned with a respective one of the detachable shields 48 for each of the battery cells 34. When one of the battery cells 34—here the battery cell 34A in FIG. 6—experiences a thermal event, the vent byproducts V can separate the detachable shield 48 from other portions of the case 38 and can push the detachable shield 48 through the associated vent opening 108 into the venting chamber 88. The vent byproducts V also move through vent opening 108 into the venting chamber 88.

The enclosure assembly 56 can be a metal or metal alloy, such as steel. The enclosure assembly 56 can be coated with a coating, such as a coating that resist rusting of the enclosure assembly 56. Both outer and inner surfaces of the enclosure assembly 56 can be coated with the coating, which is an electrocoating in some examples. In some examples, the platform 72 and the legs 76 can also be coated.

To shield coated areas from the vent byproducts, the example battery pack 14 includes a guide system 112 that constrains movement of the detachable shield 48 that has been detached from the remaining portions of the case 38 by the vent byproducts. In this example, the guide system 112 is provided by a plurality of fingers 116 that extend from the platform 72 into the venting chamber 88. The fingers 116 can extend to the floor 80 or stop just short of the floor 80.

In this examples, four fingers 116 are distributed about each of the vent openings 108. Other examples could include other numbers of fingers 116 distributed about the vent openings 108.

When the detachable shield 48 is in the detached position and pushed through the vent opening 108 by the vent byproducts, the fingers 116 essentially provide a cage that constrains movement of the detachable shield 48.

In this example, the battery cells 34 are oriented vertically and configured to vent downward to the venting chamber 88. Vertical, for purposes of this disclosure, is with reference to ground and a generally orientation of the battery pack 14 when installed within the vehicle 10.

The fingers 116 block movement of the detachable shield 48 horizontally away from an area beneath the vent opening 108. The fingers 116 maintain the detachable shield 48 in a position between the flow of vent byproducts V and the enclosure assembly 56. The vent byproducts V thus contact the detachable shield 48 rather than impinging directly on the enclosure assembly 56.

As the vent byproducts can be relatively high temperature, preventing the vent byproducts V from impinging on the enclosure assembly 56 can reduce an amount of thermal energy that is introduced to the enclosure assembly 56 and the coating of the enclosure assembly 56. This can help to inhibit any thermal event associated with the coating on the enclosure assembly 56.

In this example, the detachable shield 48 is part of the case 38. In other examples, the detachable shield 48 could instead or additionally be a thermal barrier separate from the battery cells 34. For example, a thermal barrier sheet, such as a sheet of mica, could cover the platform 72 and span over the openings 108. The cells 34 can rest atop the thermal barrier sheet. A thickness of the thermal barrier sheet can be from 0.4 to 4 millimeters.

The thermal barrier sheet can include perforations in the areas of the openings 108. During a venting event, the vent byproducts emitted from one or more of the battery cells 34 can rupture the thermal barrier sheet at the perforations causing a piece of the thermal barrier sheet to separate from the surrounding areas of the thermal barrier sheet. The vent byproducts can force the piece that has separated through the respective opening 108.

The guide system 112 limits horizontal movement of the piece that has separated. The piece of the thermal barrier sheet that has separated stays beneath the vent opening 108 and shields the enclosure assembly 56 and any coating from being directly impinged by the vent byproducts. In such an example, the piece of the thermal barrier that has separated provides the detachable shield.

In other examples, the detachable shield could be provided by a piece of a thermal barrier and a portion of the case 38 of one of the cells 34.

Features of the disclosed examples include shielding an enclosure from a direct flow of vent byproducts using a shield that is held in a shielding position by a guide system.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack venting system, comprising:
one or more battery cells;
a venting chamber adjacent the one or more battery cells, the one or more battery cells configured to vent into the venting chamber;
a detachable shield that is transitioned from an attached position to a detached position by vent byproducts emitted from one or more battery cells; and
a guide system that constrains movement of the detachable shield when the detachable shield is in the detached position.

2. The traction battery pack venting system of claim 1, further comprising a wall of the battery pack, the one or more battery cell each configured to vent a flow of vent byproducts toward the wall, the guide system configured to maintain the detachable shield in a position between the flow of vent byproducts and the wall.

3. The traction battery pack venting system of claim 2, wherein the wall is at least partially electrocoated.

4. The traction battery pack venting system of claim 2, wherein the wall is an outer wall of an enclosure.

5. The traction battery pack venting system of claim 4, wherein at least the outer wall is a coated metal or a coated metal alloy.

6. The traction battery pack venting system of claim 1, wherein the one or more battery cells are immersion cooled.

7. The traction battery pack venting system of claim 1, wherein the one or more battery cells are cylindrical battery cells.

8. The traction battery pack venting system of claim 1, wherein the venting chamber is sealed from a cell chamber that encloses the one or more battery cells such that liquid communicated through the cell chamber as part of an immersion thermal management system is blocked from entering the venting chamber.

9. The traction battery pack venting system of claim 1, further comprising a cell carrier having a platform that supports the one or more battery cells.

10. The traction battery pack venting system of claim 9, wherein the detachable shield comprises a piece of thermal shield that is disposed adjacent the platform.

11. The traction battery pack venting system of claim 9, wherein the platform includes a plurality of vent openings, the one or more battery cells each configured to vent into the venting chamber through at least one of the vent openings within the plurality of vent openings.

12. The traction battery pack venting system of claim 11, wherein the guide system includes a plurality of fingers each extending from the platform into the venting chamber, the plurality of fingers each disposed about at least one of the vent openings within the plurality of vent openings.

13. The traction battery pack venting system of claim 1, wherein the detachable shield comprises a portion of a case of the respective battery cell.

14. The traction battery pack venting system of claim 13, further comprising a cell carrier having a platform that supports the one or more battery cells, the platform includes a plurality of vent openings, the one or more battery cells each configured to vent through one or more of the vent openings into the venting chamber, the detachable shield configured to pass through the one of the vent openings when in the detached position.

15. The traction battery pack venting system of claim 14, wherein the detachable shield further includes a piece of a thermal shield.

16. The traction battery pack venting system of claim 15, wherein the thermal shield is a mica sheet.

17. A battery pack shielding method, comprising:
venting a battery cell into a venting chamber;
during the venting, transitioning a detachable shield from an attached position to a detached position; and
constraining movement of the detachable shield during the venting.

18. The battery pack shielding method of claim 17, further comprising managing thermal energy using a liquid coolant, the battery cell at least partially immersed in the liquid coolant.

19. The battery pack shielding method of claim 17, wherein movement of the detachable shield is constrained to maintain the detachable shield in a position where the detachable shield blocks a flow of vent byproducts from impinging on a portion of a wall of an enclosure that houses the battery cell.

20. The battery pack shielding method of claim 19, wherein the wall is at least partially electrocoated.
